(19) United States
(12) Patent Application Publication
(10) Pub. No.: US 2006/0036818 A1
(43) Pub. Date: Feb. 16, 2006

(54) Storage connection changing method for storage management system

(76) Inventors: Jun Mizuno, Yokohama (JP); Takeshi Ishizaki, Yokohama (JP); Kiminori Sugauchi, Yokohama (JP); Atsushi Ueoka, Yokohama (JP); Emiko Kobayashi, Yokohama (JP); Toui Miyawaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/959,971

(22) Filed: Oct. 8, 2004

(30) Foreign Application Priority Data
Jul. 28, 2004 (JP) 2004-220228

(51) Int. Cl. G06F 12/14

(52) U.S. Cl. 711/156

(57) ABSTRACT

To provide a storage connection changing method for a storage management system of setting and releasing an external connection between a primary storage system and an external storage system in a storage system, the storage management system includes a computer, the primary storage system, the external storage system, a network device, and a management device which manages the computer, the primary storage system, the external storage system, and the network device. The management device obtains a communication group information for limiting a communicable range between the computer and the storage systems from the network device, upon receiving of a request for changing an external connection state, And the management device generates a communication group information after the changing of the external connection state based on the request for changing the external connection state and the obtained communication group information.

### CLAIM OF PRIORITY

The present application claims priority from Japanese application P2004-220228 filed on Jul. 28, 2004, the content of which is hereby incorporated by reference into this application.

### FIELD OF THE INVENTION

This invention relates to a storage connection changing method which changes a storage external connection. More specifically, the invention relates to a technology which automatically sets an environment after a change of the external connection.

### BACKGROUND OF THE INVENTION

A connecting technology between computers and storage systems is changing from a connection by a Storage Area Network (SAN) using a Fibre Channel to a connection by a Storage Area Network via an IP-network (IP-SAN) such as an Internet Small Computer Systems Interface (iSCSI) or an Internet Fiber Channel Protocol (iFCP).

The IP-SAN enables setting of an access limitation, a discovery domain and a Virtual LAN (VLAN).

In the access limitation, a storage system which a connection initiator can access is set. Accordingly, the connection initiator can only access the storage system set in the access limitation.

In the discovery domain, the same discovery domain is set in the same group (group composed of a connection initiator and a storage system connectable to the connection initiator). Accordingly, when a host computer or a administrator searches the connectable storage system, the storage system only in the same group is presented.

The VLAN is set in a network device such as a router or a switch. Accordingly, a limitation is set to a range within which communication is capable through a second layer (data link layer) of an Open Source Initiative (OSI) reference model.

High-level security measures can be implemented by setting a discovery domain in an Internet Storage Name Service (iSNS) server and the VLAN in the network device together with the access limitation in the storage system.

Whereas, when a new storage system is introduced, an old storage system may be operating together with the new storage system. As a method of effectively using the old storage system in such a case, there is available a technology called an external connection function of a storage system. The external connection function is a technology which connects the new and old storage systems serially from the host computer, and shows a volume of the old storage system as that of the new storage system.

When a connection state is changed (external connection is changed) in such an external connection function, the administrator must set the access limitation, the discovery domain, and the VLAN.

Thus, there is known a technology which takes over the access limitation set in the old storage system by transferring data from the old storage system, to reduce a load on the administrator when the external connection is changed (refer to JP 2004-5370 A).

### SUMMARY OF THE INVENTION

According to the aforementioned conventional technology, the access limitation of the storage system can be automatically set when the external connection is changed. However, the discovery domain of the iSNS server or the VLAN of the network device cannot be automatically set.

Consequently, the administrator must set a corresponding discovery domain or VLAN after the external connection is changed. This is a great load on the administrator. Besides, since such setting is complex, there is a possibility that the administrator will make a mistake in setting if a range of changing the external connection is wide.

According to an embodiment of this invention, there is provided a storage connection changing method for a storage management system which changes an external connection state between a primary storage system and an external storage system in a storage system. The storage management system comprising a computer, the primary storage system directly accessed by the computer, the external storage system not directly accessed by the computer, a network device to connect the computer, the primary storage system and the external storage system, and a management device to manage the computer, the primary storage system, the external storage system and the network device. The method comprises: obtaining a communication group information for limiting a communicable range between the computer and the storage systems from the network device by the management device upon reception of a changing request of an external connection state; and generating a communication group information after the change of the external connection state by the management device based on the request for changing the external connection state and the obtained communication group information.

According to the embodiment of this invention, in the case of changing the external connection, it is possible to automatically change the state of the storage management device after the external connection is changed.

### BRIEF DESCRIPTION OF THE DRAWINGS

The present invention can be appreciated by the description which follows in conjunction with the following figures, wherein:

FIG. 1 is a block diagram of a storage management system according to an embodiment of this invention.

FIG. 2 is a block diagram of a primary storage system according to the embodiment of this invention.

FIG. 3 is a configuration diagram of logical volume constitution information stored in a database of a storage management sever according to the embodiment of this invention.

FIG. 4 is a flowchart of a process of changing an external connection by a storage connection management server according to the embodiment of this invention.

FIG. 5 is a configuration diagram of a changing the external connection request according to the embodiment of this invention.

FIG. 6 is a configuration diagram of constitution information stored in the storage management server according to the embodiment of this invention.

FIG. 7 is a configuration diagram of access limitation information stored in the storage management server according to the embodiment of this invention.

FIG. 8 is a configuration diagram of node information stored in the storage management server according to the embodiment of this invention.

FIG. 9 is a flowchart of a process of setting an access limit according to the embodiment of this invention.

FIG. 10 is a configuration diagram of discovery domain information stored in an iSNS server according to the embodiment of this invention.

FIG. 11 is a configuration diagram of iSNS node information stored in the iSNS server according to the embodiment of this invention.

FIG. 12 is a flowchart of a process of setting a discovery domain according to the embodiment of this invention.

FIG. 13 is a configuration diagram of VLAN group information stored in a network management server according to the embodiment of this invention.

FIG. 14 is a configuration diagram of VLAN host information stored in the network management server according to the embodiment of this invention.

FIG. 15 is a configuration diagram of interface information according to the embodiment of this invention.

FIG. 16 is a flowchart of a process of setting a VLAN according to the embodiment of this invention.

FIG. 17A is a configuration diagram of volume information stored in an agent before the external connection is changed according to the embodiment of this invention.

FIG. 17B is a configuration diagram of volume information stored in the agent after the external connection is changed according to the embodiment of this invention.

FIG. 18 is a configuration diagram of agent constitution information stored in the database according to the embodiment of this invention.

FIG. 19 is a flowchart of a process of changing an external connection state according to the embodiment of this invention.

### DETAILED DESCRIPTION OF THE PREFERRED EMBODIMENT

A preferred embodiment of this invention will be described below with reference to the accompanying drawings.

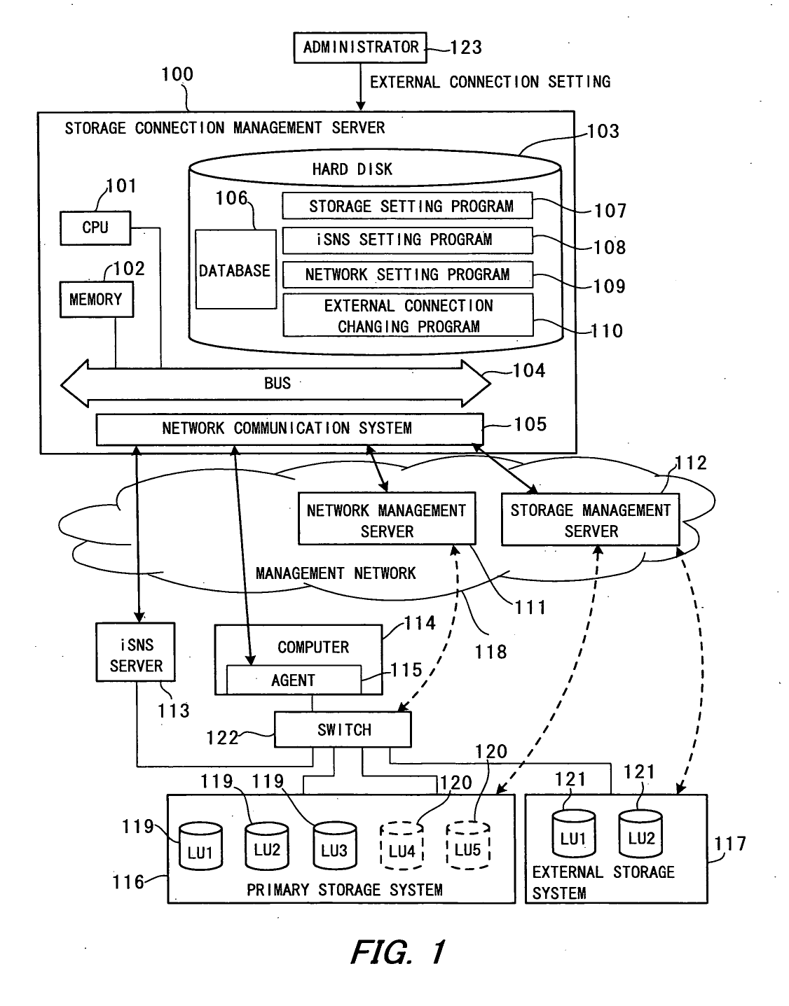

FIG. 1 is a block diagram showing a configuration of a storage management system according to an embodiment of this invention.

The storage management system of the embodiment of this invention is composed of a storage connection management server 100, a network management server 111, a storage management server 112, an iSNS server 113, a computer 114, a primary storage system 116, an external storage system 117, and a switch 122. For each of the computer 114, the primary storage system 116, the external storage system 117, and the switch 122, one device is shown, but two or more devices may be disposed.

The storage connection management server 100 is coupled to the network management server 111, the storage management server 112, the iSNS server 113, and the computer 114 through a management network 118.

Each of the iSNS server 113, the computer 114, the primary storage system 116, and the external storage system 117 is coupled to the switch 122. These components are coupled through the switch 122 to an IP network such as Internet. According to the embodiment of this invention, the management network 118 and the IP network are separate. However, they may be one and the same network.

The storage connection management server 100 is composed of a CPU 101, a memory 102, a hard disk 103, a bus 104, and a network communication system 105.

The CPU 101 performs various operations by executing programs stored in the memory 102. The memory 102 temporarily stores information or the like input/output on the hard disk 103.

The hard disk 103 stores a storage setting program 107, an iSNS setting program 108, a network setting program 109, and an external connection changing program 110. And the hard disk 103 stores a database 106.

The storage setting program 107 obtains and changes information of the storage management server 112 (e.g., information on setting of access limitation). The iSNS setting program 108 obtains and changes information of the iSNS sever 113 (e.g., information on setting of discovery domain). The network setting program 109 obtains and changes information of the network management server 111 (e.g., information on setting of VLAN). The external connection changing program 110 obtains and changes information of an agent 115 (e.g., information on setting of storage of connection target of computer 114, described later). The database 106 stores the obtained information or the like.

Each of the network management server 111, the storage management server 112, the iSNS server 113, and the computer 114 is a computer equipment which is composed of a CPU, a memory, an I/O device, and a network interface. And the CPU of those computer equipments performs arithmetic operations by executing programs stored in the memory. According to the embodiment of this invention, the storage connection management server 110, the network management server 111, the storage management server 112, and the iSNS server 113 are different computer equipments. However, these servers may be constituted on the same hardware.

A disk drive is disposed in the primary storage system 116, and three internal volumes 119 are constituted by the disk drive. Unique identifiers (LUN) of “1”, “2”, and “3” are set to the three internal volumes 119.

Similarly, the external storage system 117 is composed of two external volumes 121. Unique identifiers (LUN) of “1” and “2” are set to the two external volumes 121.

The primary storage system 116 includes two virtual volumes 120 in addition to the internal volumes 119. By setting the external volumes 121 of the external storage system 117 as the virtual volumes 120, the primary storage system 116 seems as if it has the external volumes 121.

For example, when there is access to the virtual volume 120, the primary storage system 116 relays it to the external volume 121 corresponding to the accessed virtual volume 120.

The computer 114 is composed of an agent 115 operated thereon. The agent 115, when the external connection is changed, operates a logical volume to be accessed seems as if it is not changed from an application operated on the computer 114.

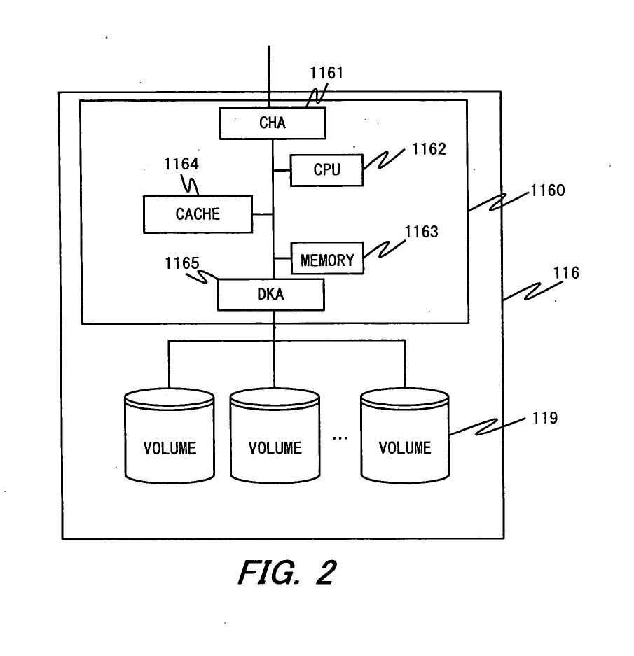

FIG. 2 is a block diagram showing a configuration of the primary storage system 116 according to the embodiment of this invention.

The primary storage system 116 of the embodiment of this invention is composed of a controller 1160 and an interval volume 119.

The controller 1160 is composed of channel adaptors 1161A, 1161B, a CPU 1162, a memory 1163, a cache memory 1164, and a disk adaptor 1165.

A control program is stored in the memory 1163. The CPU 1162 performs various operations by loading and executing the control program.

The controller 1160 controls data input/output on the internal volume 119 by operating the control program.

The channel adaptor 1161A is an interface for a primary system such as the computer 114 or the like. The channel adaptor 1161A transfers data or a control signal with the iSNS server 113 and the computer 114 through the switch 122.

The channel adaptor 1161B is an interface for the external storage system 117. The channel adaptor 1161B transfers data or a control signal with the external storage system 117 through the switch 122.

That is, the CPU 1162 controls the primary storage system 116 to seem as if it has an external volume 121 by transferring access to the virtual volume 120 of the primary storage system 116 from the channel adaptor 1161A to the channel adaptor 1161B.

The disk adaptor 1165 is an interface for the internal volume 119. For example, the disk adaptor 165 transfers data or a control signal with the internal volume 119 based on Fibre Channel protocol.

The cache memory 1164 is a memory which temporarily stores data transferred between the channel adaptor 1161 and the disk adaptor 1165.

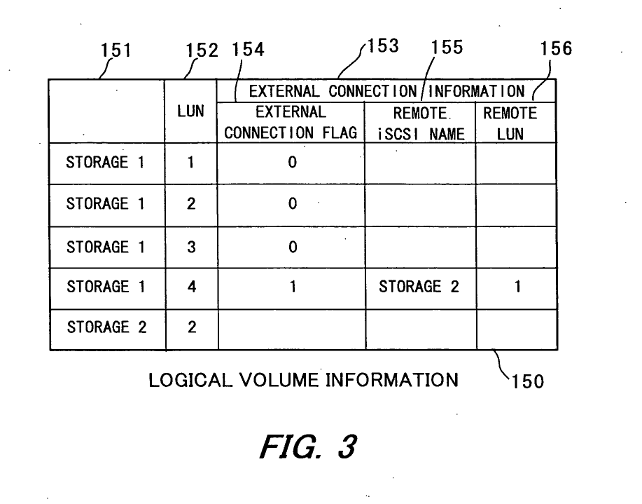

FIG. 3 is a configuration diagram showing logical volume constitution information stored in the database 106 of the storage connection management server 100 of the embodiment of this invention.

The logical volume constitution information 150 includes an iSCSI name 151, a Logical Unit Number (LUN) 152, and external connection information 153. The storage connection management server 100 manages the logical volume according to such information.

The iSCSI name 151 is an identifier of an iSCSI node of the primary storage system 116. The LUN 152 is an identifier of a logical volume set in the primary storage system 116.

The external connection information 153 includes an external connection flag 154, a Remote iSCSI name 155, and a Remote LUN 156. The external connection flag 154 indicates whether the logical volume is a virtual volume 120. That is, if the external connection flag 154 is “1”, its logical volume is a virtual volume 120. If the external connection flag 154 is “0”, its logical volume is an internal volume 119.

The Remote iSCSI name 155 is an identifier of an iSCSI node of the external storage system 117 corresponding to the virtual volume. The Remote LUN 156 is an identifier of an external volume 121 corresponding to the virtual volume. The Remote iSCSI name 155 and the Remote LUN 156 are used only when the external connection flag 154 is “1” (a logical volume is the virtual volume 120), and not used when the flag is “0” (a logical volume is the internal volume 119).

According to the embodiment of this invention, the iSCSI name 151 of the primary storage system 116 is a “storage 1”, and the iSCSI name 151 of the external storage system 117 is a “storage 2”.

The “storage 1” has internal volumes 119 of LUNs “1”, “2”, and “3”, and a virtual volume 120 of LUN “4”. When there is access to the virtual volume 120 of the LUN “4”, the primary storage system 116 (storage 1) transfers the access to the external volume of the LUN “1” of the external storage system 117 (storage 2).

The storage connection management server 100 notifies the logical volume constitution information 150 according to a request of an administrator 123. The administrator 123 refers to the logical volume constitution information 150, and requests the storage connection management server 100 to change the external connection when a change of the external connection is necessary.

Upon reception of the external connection changing request of the primary storage system 116 from the administrator 123, the storage connection management server 100 automatically sets an access limitation, a discovery domain, a VLAN, and an external connection state. At this time, the storage connection management server 100 automatically sets such based on information obtained from the storage management server 112, the iSNS server 113, the network management server 111, the agent 115 and the like.

Hereinafter, description will be made of a change of the external connection when the primary storage system 116 (storage 1) controls the LUN “2” of the external storage system 117 (storage 2) to seem as if it is a LUN “5” of the primary storage system 116 (storage 1).

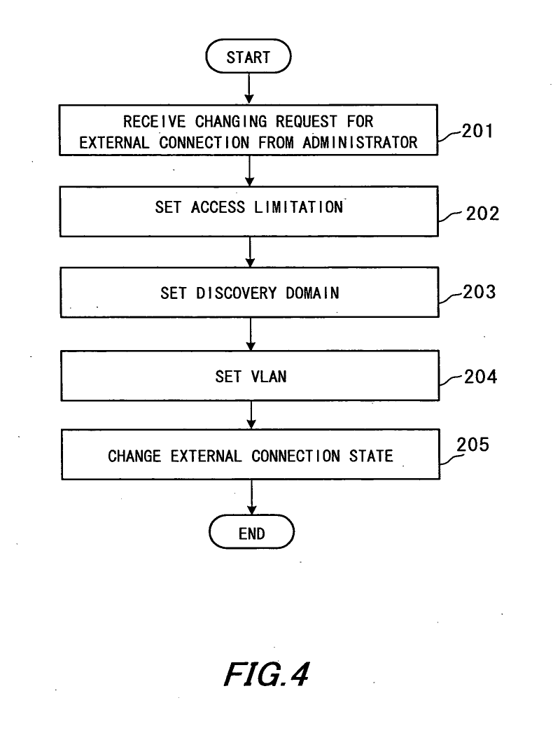

FIG. 4 is a flowchart showing a process of changing the external connection by the storage connection management server 100 according to the embodiment of this invention.

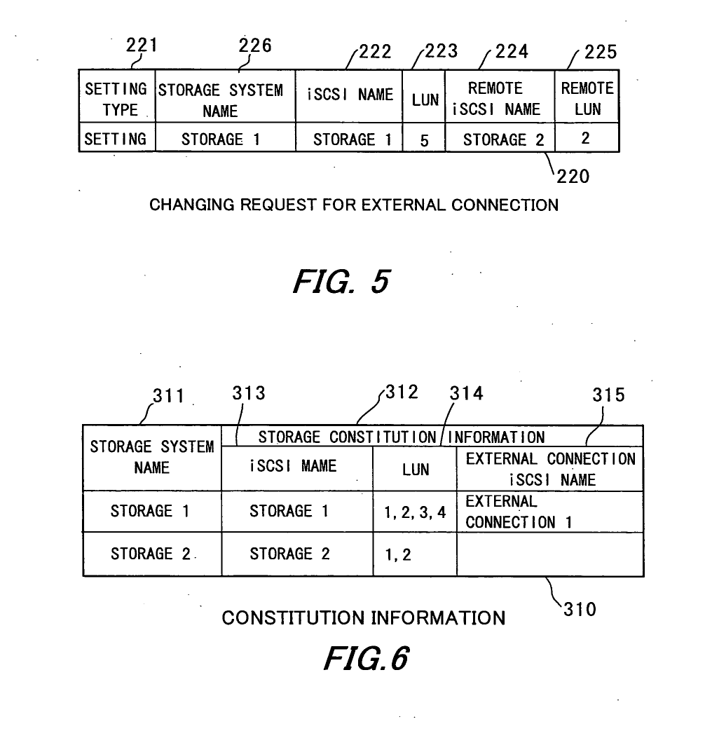

First, the storage connection management server 100 receives a changing request of the external connection shown in FIG. 5 from the administrator 123 (201).

FIG. 5 is a am configuration diagram showing the request of changing the external connection according to the embodiment of this invention. This changing request of the external connection is for controlling the LUN “2” of the “STORAGE 2” to seem as if it is a LUN “5” of the “STORAGE 1”.

The changing request of the external connection 220 includes a setting type 221, a storage system name 226, an iSCSI name 222, a LUN 223, a Remote iSCSI name 224, and a Remote LUN 225.

The setting type 221 is “SET” or “RELEASE”. The “SET” means a request to set a new external connection. The “RELEASE” means a request to release the set external connection.

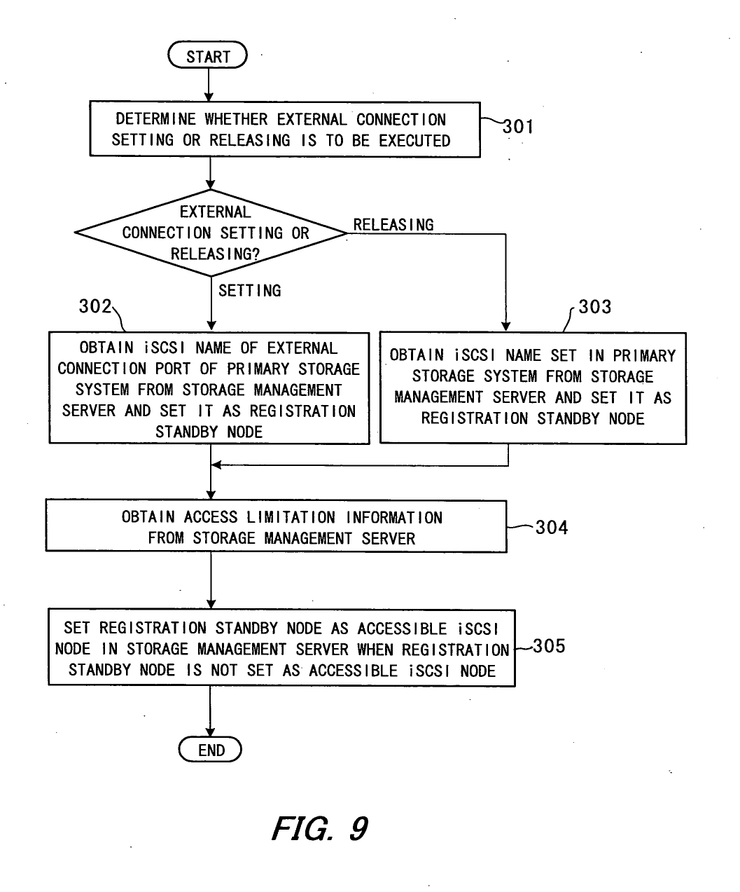

Referring back to FIG. 4, after the storage connection management server 100 has received the changing request of the external connection 220, the storage setting program 107 sets an access limitation for the storage management server 112 as shown in FIG. 9 (202).

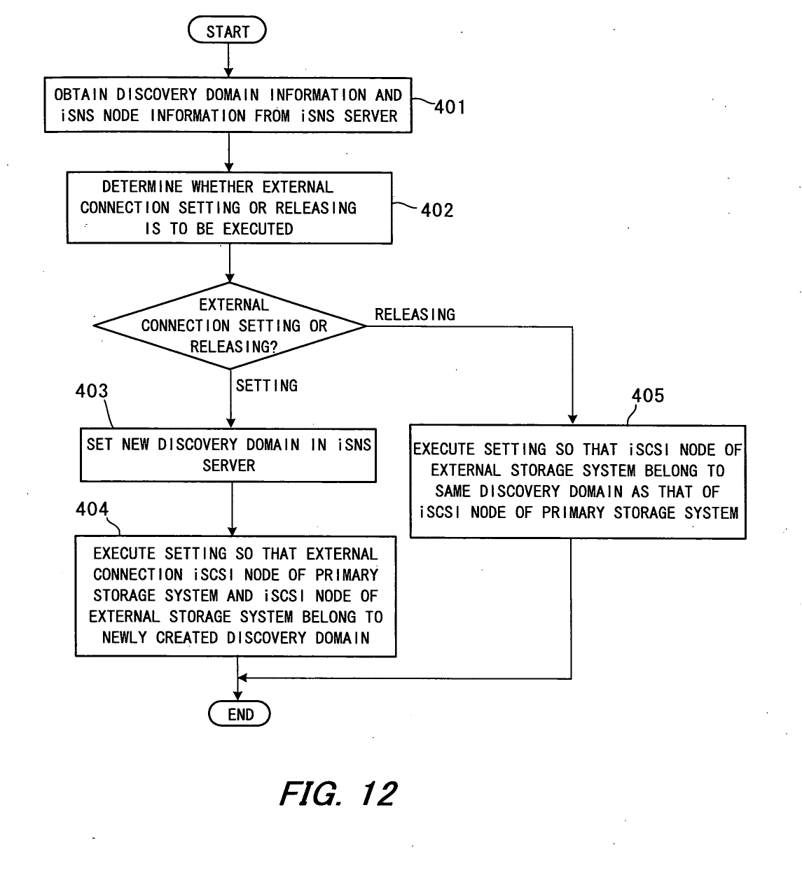

Next, the iSNS setting program 108 sets a discovery domain for the iSNS server 113 as shown in FIG. 12 (203).

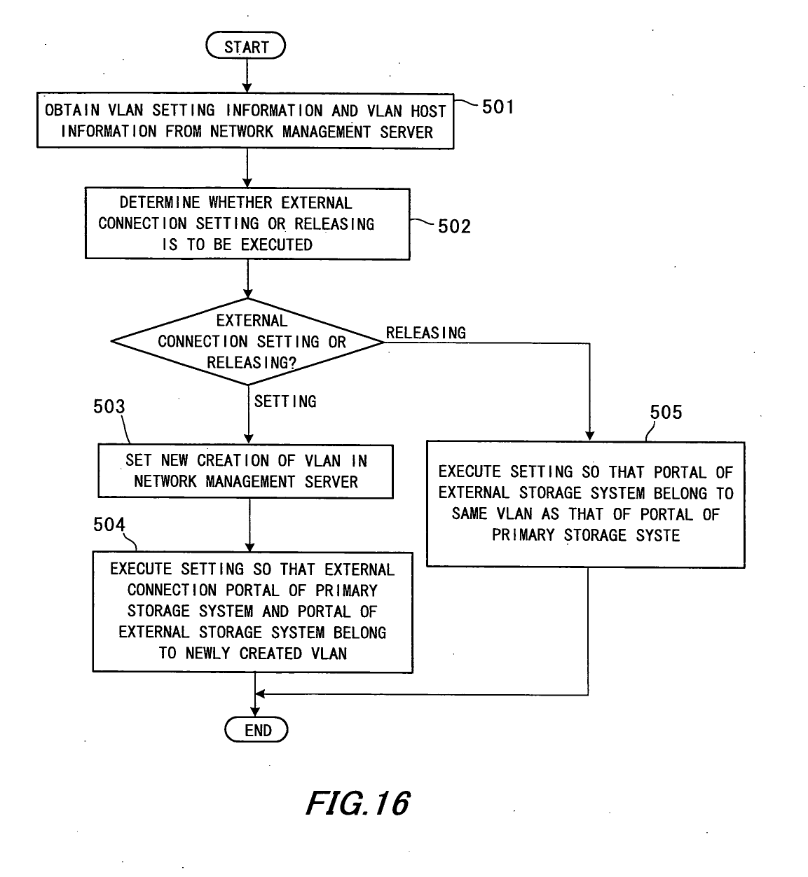

Then, the network setting program 109 sets a VLAN for the network management server 111 as shown in FIG. 16 (204).

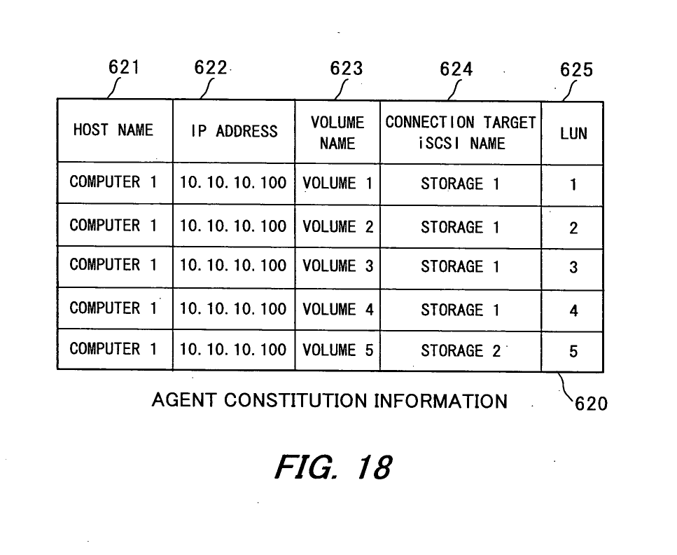

Further, the external connection changing program 110 changes an external connection state as shown in FIG. 18 (205).

Thus, the changing of the external connection is completed.

Next, the process of setting the access limitation (step 202 of FIG. 4) will be described in detail.

First, various information used for the process of setting the access limitation will be described.

The storage management server 112 stores constitution information, an access limitation information, and a node information (these are shown in FIG. 6 to FIG. 8). The storage management server 112 notifies such information according to a request from the storage connection management server 100 the primary storage system 116 or the external storage system 117.

The storage management server 112, the storage connection management server 100, the primary storage system 116, and the external storage system 117 communicate with one another by using a Simple Network Management Protocol (SNMP) or a Common Information Model (CIM). Additionally. An API or a protocol of storage management server 112's own may be used.

FIG. 6 is a configuration diagram showing the constitution information stored in the storage management server 112 of the embodiment of this invention.

One record of the constitution information 310 is prepared for each storage system, and includes a storage system name 311 and storage constitution information 312.

The storage system name 311 is an identifier of a storage system. The constitution information 310 of this embodiment contains a record in which the storage system name 311 is a “STORAGE 1” and a record in which the storage system name 311 is a “STORAGE 2”.

The storage constitution information 312 includes an iSCSI name 313, a LUN 314, and an external connection iSCSI name 315.

The iSCSI name 313 is an identifier of an iSCSI node of the storage system. The LUN 314 is an identifier of a logical volume set in the storage system. The external connection iSCSI name 315 is an identifier of an iSCSI node of a port through which the storage system accesses the external storage system.

Each of the iSCSI name 313, the LUN 314, and the external connection iSCSI name 315 can have a plurality of values when plural identifiers sets are in one storage system.

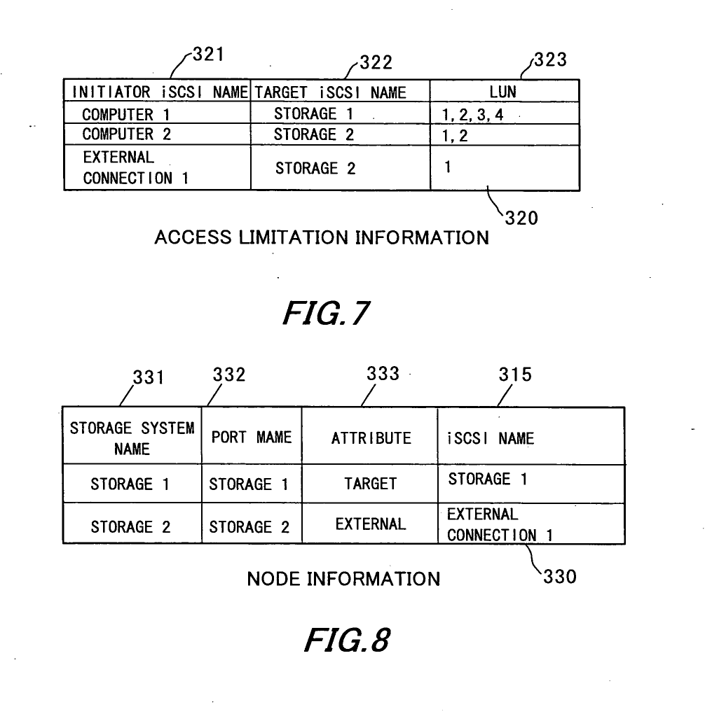

FIG. 7 is a configuration diagram showing the access limitation information stored in the storage management server 112 of the embodiment of this invention.

The access limitation information 320 includes an Initiator iSCSI name 321, a Target iSCSI name 322, and a LUN 323. The Initiator iSCSI name 321 is an identifier of an iSCSI node of a connection initiator. The Target iSCSI name 322 is an identifier of an iSCSI node of a storage system of a connection target. The LUN 323 is an identifier of a logical volume set in the storage system of the connection target.

Upon receiving of a request of reading/writing in the logical volume from the computer 114 or the like, the storage system obtains the access limitation information 320 from the storage management server 112. Then, by referring to the obtained access limitation information 320, the storage system compares the requested identifier of the computer 114 or the like with the Initiator iSCSI name 321, and further compares its own identifier with the Target iSCSI name 322. Only when both of Initiator iSCSI name and Target iSCSI name coincide with each other, the storage system permits reading/writing in the logical volume.

In the access limitation information 320 of the embodiment, the connection initiator and the connection target to which access is permitted are stored. However, a connection initiator and a connection target to which access is not permitted may be stored.

FIG. 8 is a configuration diagram showing node information stored in the storage management server 112 of the embodiment of this invention.

The node information 330 includes a storage system name 331, a port name 332, an attribute 333, and an iSCSI name 334.

The storage system name 331 is an identifier of a storage system. The port name 332 is an identifier of a port of the storage system.

The attribute 333 is an attribute of the port, which is “Target” or “External”. If the storage system is a connection target, the port that has a Target attribute is used. On the other hand, if the storage system is a connection initiator, the port that has an External attribute is used. The iSCSI name 334 is an identifier of an iSCSI node of the port.

FIG. 9 is a flowchart showing a process of setting an access limitation in step 202 of FIG. 4.

First, the storage setting program 107 extracts the setting type 221 from the changing request of the external connection 220, and determines whether to set or release the external connection (301).

When setting the external connection, the storage setting program 107 extracts the storage system name 226 (storage 1) from the changing request of the external connection 220. Next, the storage setting program 107 obtains the node information 330 from the storage management server 112.

Then, the storage setting program 107 extracts the iSCSI name 334 which coincides with the storage system name 331 and the storage system name 226 (storage 1) extracted from the changing request of the external connection 220, and whose attribute is “External” from the obtained node information 330. In the case of the node information 330 shown in FIG. 8, “EXTERNAL CONNECTION 1” is extracted.

The storage setting program 107 stores the obtained iSCSI name 334 (external connection 1) as a registration standby node in the database 106 (302).

The storage setting program 107 obtains a record of the access limitation information 320 in which the iSCSI name (external connection 1) of the registration standby node coincides with the Initiator iSCSI name 321 from the storage management server 112 (304).

Then, the storage setting program 107 collates the changing request of the external connection 220 with the obtained record of the access limitation information 320. In detail, the storage setting program 107 compares the Remote iSCSI name 224 (storage 2) with the Target iSCSI name 322, and the Remote LUN 225 (2) with the LUN 323. The storage setting program 107 determines whether there is a record of which both of the iSCSI name and the LUN coincide in access limitation information 320

The storage setting program 107 finishes the processing if there is a record of which both of the iSCSI name and the LUN coincide in access limitation information 320. On the other hand, if there is no record of which both of the iSCSI name and the LUN coincide in access limitation information 320, the storage setting program 107 sends a request of setting the access limitation information 320 which contains information on the iSCSI name (external connection 1) of the registration standby node and the changing request of the external connection 220 to the storage management server 112.

Upon receiving of the request of setting the access limitation information 320, the storage management server 112 sets the storage system name 226 (storage 1) of the changing request of the external connection 220 in the storage system name 311 of the constitution information 310. Additionally, the storage management server 112 sets the iSCSI name 222 (storage 1) of the changing request of the external connection 220 in the iSCSI name 313, a LUN 223 (5) of the changing request of the external connection 220 in the LUN 314, and the iSCSI name (external connection 1) of the registration standby node in the external connection iSCSI name 315.

In this case, when the same name is present in the storage system name 311, values only of the LUN 314 and the external connection iSCSI name 315 are added. That is, according to the embodiment of this invention, “5” needs be added to the LUN 314 of the constitution information 310.

Next, the storage management server 112 sets the iSCSI name (external connection 1) of the registration standby node in the Initiator iSCSI name 321 of the access limitation information 320. Additionally, the storage management server 112 sets the Remote iSCSI name 224 (storage 2) of the changing request of the external connection 220 in the Target iSCSI name 322, and the Remote LUN 225 (2) of the changing request of the external connection 220 in the LUN 323 (305).

At this time, when there are identical names in the Initiator iSCSI name 321 and the Target iSCSI name 322, a value only of the LUN 323 is added. That is, according to the embodiment of this invention, “2” needs be added to the LUN 323.

On the other hand, when the external connection is released in step 301, the process proceeds to step 303. By referring to the access limitation information 320, the storage setting program 107 compares the iSCSI name 222 of the changing request of the external connection 220 with the Target iSCSI name 322, and further compares the LUN 223 of the changing request of the external connection 220 with the LUN 323. Then, the storage setting program 107 obtains the Initiator iSCSI name 321 of the record in which both of the iSCSI name and the LUN coincide from the storage management server 112.

Then, the storage setting program 107 stores the obtained Initiator iSCSI name 321 as an iSCSI name of a registration standby node in the database 106 (303).

The subsequent process is similar to that of step 304 and after when the external connection is set.

Next, the process of setting the discovery domain (step 203 of FIG. 4) will be described in detail.

First, various information used for the process of setting the discovery domain will be described.

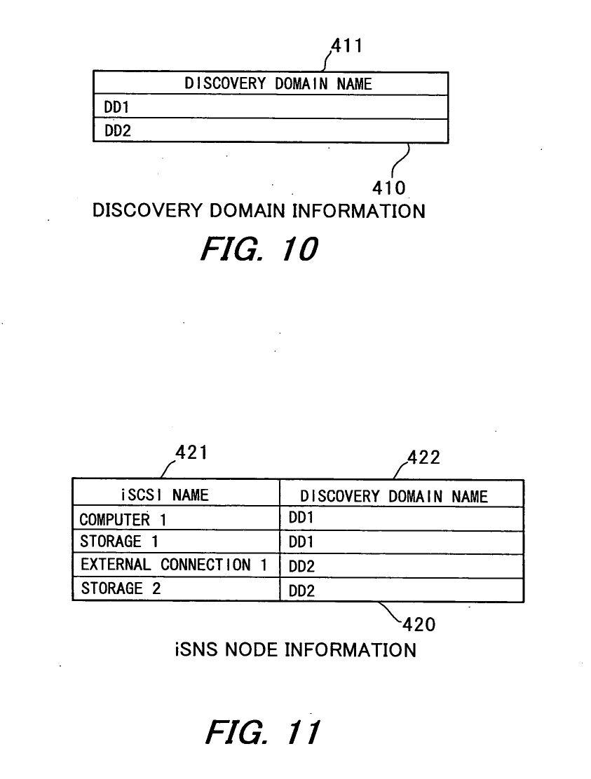

The iSNS server 113 stores discovery domain information and an iSNS node information (these are shown in FIG. 10 and FIG. 11). The iSNS server 113 notifies information according to a request from the storage connection management server 100 or the switch 122. Here, the iSNS server 113, the storage connection management server 100, and the switch 122 communicate with one another by using the SNMP.

FIG. 10 is a configuration diagram showing the discovery domain information stored in the iSNS server 113 of the embodiment of this invention.

The discovery domain information 410 includes a discovery domain name 411. The discovery domain name 411 uniquely identifies a group. By setting the same discovery domain name in the same group (group composed of a connection initiator and a storage connectable to the connection initiator), the storage system in the same group can be presented when the administrator 123 or the computer 114 searches the connectable storage system.

Referring to FIG. 10, “DD1” and “DD2” are set in the discovery domain name 411. The discovery domain information 410 of FIG. 10 shows after the completion of changing the external connection to control the LUN “2” of the “STORAGE 2” to seem as if it is the LUN “5” of the “STORAGE 1”. Initially, the “DD1” only is set in the discovery domain information 410.

FIG. 11 is a configuration diagram showing the iSNS node information stored in the iSNS server 113 of the embodiment of this invention.

The iSNS node information 420 includes an iSCSI name 421 and a discovery domain name 422. According to the embodiment of this invention, the iSCSI name 421 is set in the iSCSI node of the “COMPUTER 1” and the “STORAGE 1”, and the discovery domain name 422 is set in the “DD1”. The “COMPUTER 1” is an iSCSI name of the computer 114 connected to the primary storage system 116 (storage 1). For example, when the “COMPUTER 1” searches the connectable storage system, the “STORAGE 1” in which the same discovery domain name 421 (DD 1) is set is presented.

In the iSNS node information 420 of FIG. 11, the iSCSI name 421 is set in a record of the iSCSI node of the “EXTERNAL CONNECTION 1” and the “STORAGE 2”, and the discovery domain name 422 is set in the “DD2”. The iSNS node information 420 of FIG. 11 show after the completion of changing the external connection to control the LUN “2” of the “STORAGE 2” to seem as if it is the LUN “5” of the “STORAGE 1”. Initially, these records are not set in the iSNS node information 420.

FIG. 12 is a flowchart showing the process of setting the discovery domain in step 203 of FIG. 4.

First, the iSNS setting program 108 obtains the discovery domain information 410 and the iSNS mode information 420 from the iSNS server 113 (401).

Next, the iSNS setting program 108 extracts the setting type 221 from the changing request of the external connection 220, and determines whether to set or release the external connection (402).

When setting the external connection, the iSNS setting program 108 creates a “DD2” of a new discovery domain name not contained in the obtained discovery domain information 410. Then, the iSNS setting program 108 adds and sets the created discovery domain name (DD2) in the discovery domain information 410 (403).

Next, the iSNS setting program 108 obtains the storage system name 226 (storage 1) from the changing request of the external connection. By referring to the constitution information 310, the iSNS setting program 108 extracts an external connection iSCSI name 315 (external connection) in which the obtained storage system name 226 (storage 1) coincides with the storage system name 311. The iSNS setting program 108 sends an iSNS node addition request. The iSNS node addition request includes the obtained external connection iSCSI name 315 (external connection 1) and the created discovery domain name (DD2) to the iSNS server 113.

Similarly, the iSNS setting program 108 sends an iSNS node addition request. The iSNS node addition request includes the Remote iSCSI name 224 (storage 2) of the changing request of the external connection 220 and the created discovery domain name (DD2) to the iSNS server 113.

Upon reception of the iSNS node addition request, the iSNS server 113 adds the Remote iSCSI name 224 (storage 2) to the iSCSI name 421 of the iSNS node information 420. Further, the iSNS server 113 adds the discovery domain name (DD2) of the iSNS node addition request to the discovery domain name 422 of the added record of the iSNS node information 420. Then, the iSNS node information 420 is set as shown in FIG. 10.

By this process, the external connection iSCSI node of the primary storage system 116 and the iSCSI node of the external storage system 117 are set to belong to the new discovery domain (404).

On the other hand, when the external connection is released in step 402, the process proceeds to step 405. The iSNS setting program 108 extracts from the iSNS node information 420, the discovery domain name 422 in which the iSCSI name 222 of the changing request of the external connection 220 coincides with the iSCSI name 421 of the iSNS node information 420.

Next, the iSNS setting program 108 sends the iSNS node addition request. The iSNS node addition request includes the Remote iSCSI name 224 of the changing request of the external connection 220 and the extracted discovery domain name 422 to the iSNS server 113.

Upon reception of the iSNS node addition request, the iSNS server 113 adds the Remote iSCSI name 224 to the iSCSI name 421 of the iSNS node information 420. Further, the iSNS server 113 adds the discovery domain name of the iSNS node addition request to the discovery domain name 422 of the added record of the iSNS node information 420 (405).

Next, the process of setting the VLAN (step 204 of FIG. 4) will be described in detail.

First, various information used for the process of setting the VLAN will be described.

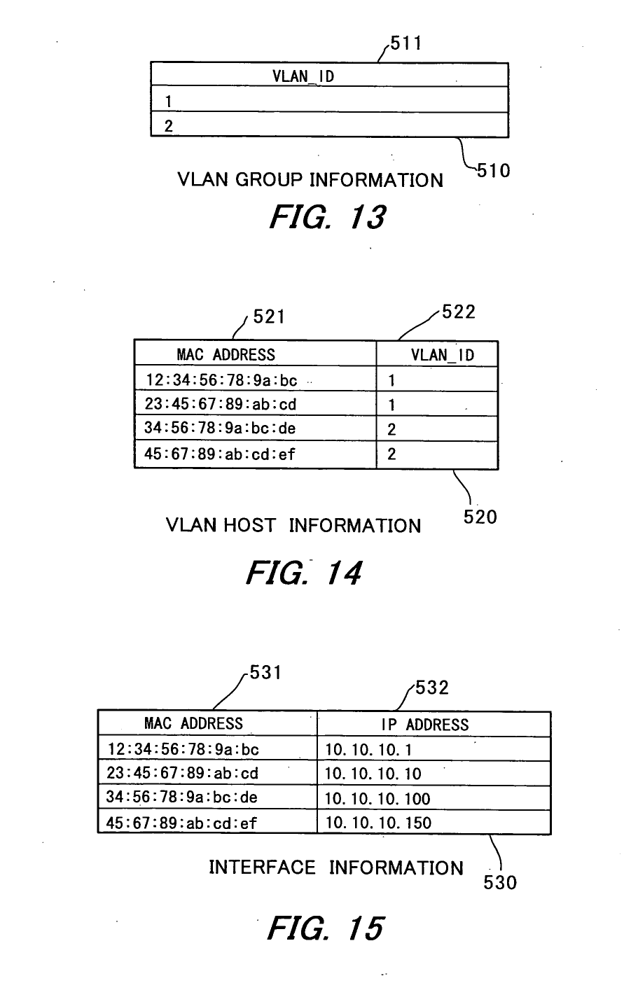

The network management server 111 stores VLAN group information and VLAN host information (these are shown in FIG. 13 and FIG. 14). The network management server 111 supplies such information according to a request from the storage connection management server 100 or the switch 122. The network management server 111 communicates with the storage connection management server 100, and the switch 122 by using the SNMP.

FIG. 13 is a configuration diagram showing the VLAN group information stored in the network management server 111 of the embodiment of this invention.

The VLAN group information 510 includes a VLAN_ID 511 which uniquely identifies a VLAN. In the second layer (data link layer) of the OSI reference model, by setting the VLAN_ID 511 in network devices, the network devices only of the same VLAN_ID 511 can communicate with each other.

FIG. 14 is a configuration diagram showing the VLAN host information 520 stored in the network management server 111 of the embodiment of this invention.

The VLAN host information 520 includes a MAC address 521 and a VLAN_ID 522. One record of the VAN host information 520 is generated for each MAC address 521. The VLAN_ID 522 is an identifier of a VLAN corresponding to the MAC address 521.

The primary storage system 116, the external storage system 117, and the computer 114 store an interface information shown in FIG. 15, and notify the information according to a request from the storage connection management server 100. The primary storage system 116, the external storage system 117, and the computer 114 communicate with the storage connection management server 100 by using the SNMP.

FIG. 15 is a configuration diagram showing the interface information 520 according to the embodiment of this invention.

The interface information 520 is generated for each interface, and includes a MAC address 531 and an IP address 532. The MAC address 531 is a MAC address of an interface of the device. The IP address 532 is an IP address of the interface of the device.

FIG. 16 is a flowchart showing the process of setting the VLAN in step 204 of FIG. 4.

First, the network setting program 109 obtains the VLAN group information 510 and the VLAN host information 520 from the network management server 111 (501).

Next, the network setting program 109 extracts the setting type 221 from the changing request of the external connection 220, and determines whether to set or release the external connection.

When setting the external connection, the network setting program 109 creates a new VLAN_ID (3) different from the VLAN_ID 511 (1 and 2) contained in the obtained VLAN group information 510. Then, the network setting program 109 adds and sets the created VLAN_ID (3) in the VLAN group information 510 (503).

The network setting program 109 extracts the iSCSI name 222 (storage 1) from the changing request of the external connection 220. The network setting program 109 obtains an IP address from the storage system of the extracted iSCSI name 222 (storage 1). Then, by referring to the interface information 530, the network setting program 109 obtains a MAC address 531 in which the obtained IP address coincides with the IP address 532.

Then, the network setting program 109 sends a VLAN setting request. The VLAN setting request includes the obtained MAC address 531 and the created VLAN_ID (3) to the network management server 111.

The network management server 111 adds the MAC address 531 of the VLAN setting request to the MAC address 521 of the VLAN host information 520. Further, the network management server 111 adds the VLAN_ID (3) of the VLAN setting request to the VLAN_ID 522 of the VLAN host information 520.

Next, the network setting program 109 extracts the Remote iSCSI name 224 (storage 2) from the changing request of the external connection 220. For a portal of the “STORAGE 2”, the network setting program 109 adds a new VLAN_ID (3) to the VLAN host information as in the case of the “STORAGE 1” (504).

On the other hand, when the external connection is released in step 502, the network setting program 109 extracts the iSCSI name 222 from the changing request of the external connection. The network setting program 109 obtains the IP address from the primary storage system 116 of the iSCSI name 222. Then, by referring to the interface information 530, the network setting program 109 obtains the MAC address 531 in which the obtained IP address coincides with the IP address 532.

Then, the network setting program 109 extracts from the obtained VLAN host information 520, the VLAN_ID 522 in which the obtained MAC address 531 coincides with the MAC address 521 of the VLAN host information 520. This VLAN_ID 522 is a VLAN_ID set to the external connection portal of the primary storage system 116.

Next, the network setting program 109 extracts the Remote iSCSI name 224 from the changing request of the external connection 220.

The network setting program 109 obtains an IP address from the external storage system 117 which is the extracted Remote iSCSI name 224. Then, by referring to the interface information 530, the network setting program 109 obtains the MAC address 531 in which the obtained IP address coincides with the IP address 532.

Then, the network setting program 109 sends the VLAN setting request including the VLAN_ID set to external connection portal of the primary storage system 116.

Upon receiving of the VLAN setting request, the network management server 111 adds the MAC address of the VLAN setting request to the MAC address 531 of the VLAN host information 520, and adds the VLAN_ID of the VLAN setting request to the VLAN_ID 522 of the VLAN host information 520.

Accordingly, the portal of the primary storage system 116 and the portal of the external storage system 117 belong to the same VLAN (505).

According to the embodiment of this invention, the VLAN is set corresponding to the MAC address. However, a VLAN of the other system such as a port VLAN or a tagged VLAN may be set.

Next, the process of changing the external connection state (step 205 of FIG. 4) will be described in detail.

First, various information used for the process of changing the external connection state will be described.

The storage management server 112 stores the logical volume constitution information 150 as in the case of the storage connection management server 100. The storage management server 112 notifies the information according to a request from the storage connection information 100. Here, the storage management server 112 and the storage connection management server 100 communicate with each other by using the SNMP or the CIM.

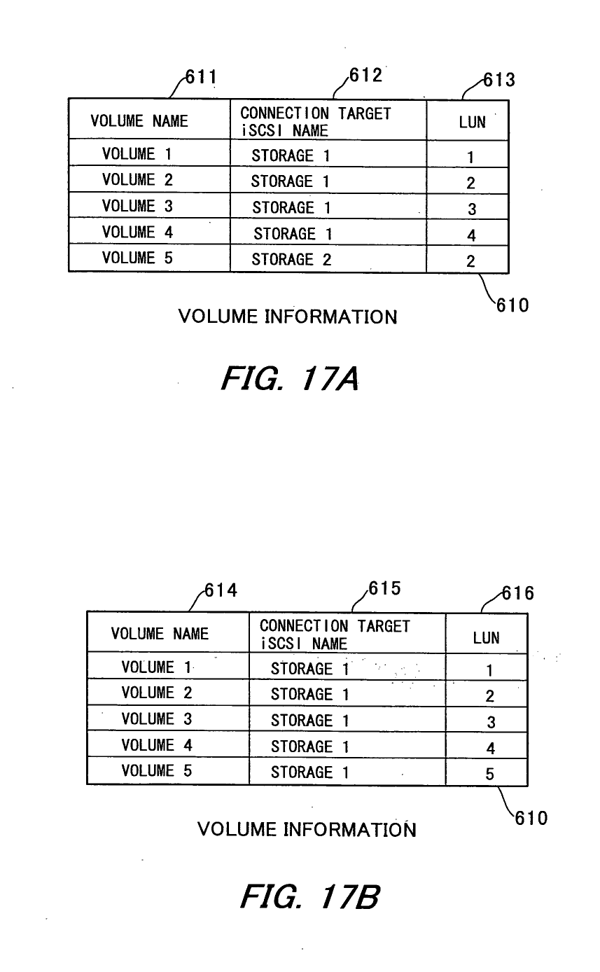

The agent 115 stores the volume information exemplified in FIGS. 17A and 17B. The agent 115 notifies the information according to a request from the storage connection management server 100. The agent 115 and the storage connection information 100 communicate with each other by using the SNMP.

FIG. 17A and FIG. 17B is a configuration diagram showing the volume information stored by the agent 115 of the embodiment of this invention. FIG. 17A shows the external connection before a change, and FIG. 17B shows the external connection after the change.

The volume information 610 is generated for each logical volume managed by the agent 115, and includes volume names 611, 614, connection target iSCSI names 612, 615, and LUNs 613, 616.

Each of the volume names 611 and 614 is an identifier by which a computer application identifies the logical volume. Each of the connection target iSCSI names 612, 615 is an iSCSI name of the iSCSI node of the storage system which has the logical volume. Each of the LUN's 613, 616 is a LUN of the logical volume.

FIG. 18 is a configuration diagram showing an agent constitution information stored in the database of the embodiment of this invention.

The agent constitution information 620 is stored in the database 106 of the storage connection management server 100.

The agent constitution information 620 is generated for each agent, and includes a host name 621, an IP address 622, a volume name 623, a connection target iSCSI name 624, and a LUN 625.

The host name 621 is an identifier of the computer 114 in which the agent 115 is operated. The IP address 622 is an IP address of the computer 114 in which the agent 115 is operated. The volume name 623 is an identifier by which the application of the computer 114 identifies the logical volume. The connection target iSCSI name 624 is an iSCSI name of the storage system which has the logical volume. The LUN 625 is an LUN of the logical volume.

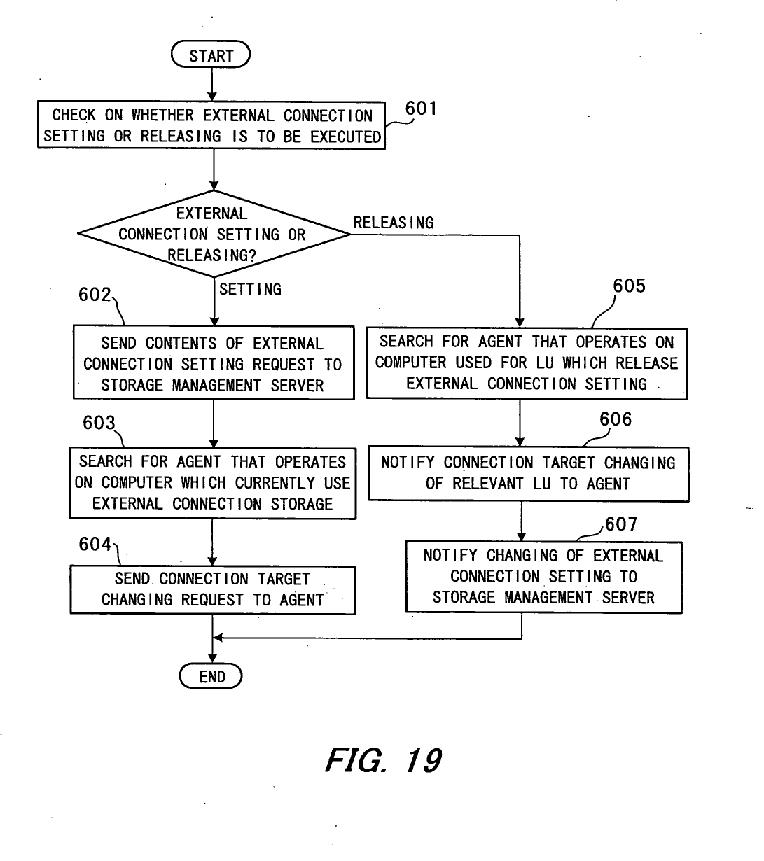

FIG. 19 is a flowchart showing the process of changing the external connection state in step 205 of FIG. 4.

First, the external connection changing program 110 extracts the setting type 221 from the changing request of the external connection 220, and determines whether to set or release the external connection.

In the case of setting the external connection, the external connection changing program 110 sends information including the iSCSI name 222 of the changing request of the external connection 220, the LUN 223, the Remote iSCSI name 224, and the Remote LUN 225 to the storage management server 112 (602).

Upon receiving of the information, by referring to the logical volume constitution information 150, the storage management server 112 compares the Remote iSCSI name 224 (storage 2) with the iSCSI name 151. Further, the storage management server 112 compares the Remote LUN 225 (2) with the LUN 152. Then, the storage management server 112 extracts the record of the logical volume constitution information 150 in which both of the iSCSI name and the LUN coincide with each other.

The storage management server 112 changes the extracted record. Specifically, for the extracted record, the storage management server 112 changes the iSCSI name 151 to the iSCSI name 222 (storage 1) of the changing request of the external connection 220, the LUN 152 to the LUN 223 (5) of the changing request of the external connection 220, an external connection flag 154 to “1”, the Remote iSCSI name 155 to the Remote iSCSI name 224 (storage 2) of the changing request of the external connection 220, and the Remote LUN 156 to the Remote LUN 225 (2) of the changing request of the external connection 220.

Next, by referring to the changing request of the external connection 220 and the agent constitution information 620, the external connection changing program 110 obtains the host name 621 of the computer 114 which accesses the external storage system 121. The external connection changing program 110 searches the agent 115 from the computer 114 of the obtained host name 621 (603).

By referring to the agent constitution information 620, the external connection changing program 110 compares the Remote iSCSI name 224 (storage 2) with the connection target iSCSI name 624, and further compares the Remote LUN 225 (2) with the LUN 625.

Then, the external connection changing program 110 obtains one record of the agent constitution information 620 in which both of the connection iSCSI name and the LUN coincide with each other. For the obtained record of the agent constitution information 620, the external connection changing program 110 changes the connection target iSCSI name 624 to the iSCSI name 222 (storage 1) of the changing request of the external connection 220, and the LUN 625 to the LUN 223 (5) of the changing request of the external connection 220.

Next, the external connection changing program 110 collates the changing request of the external connection 220 with the volume information 610. In detail, the external connection changing program 110 compares the Remote iSCSI name 224 (storage 2) with the connection target iSCSI name 611, and the Remote LUN 225 (2) with the LUN 613. Then, the external connection changing program 110 obtains a volume name 611 (volume 5) in which both of the iSCSI name and the LUN coincide with each other. The external connection changing program 110 sends a connection target changing request. The connection target changing request includes the obtained volume name 611 (volume 5), the iSCSI name 222 (storage 1) of the changing request of the external connection, and the LUN 223 (5) of the changing request of the external connection to the agent 115 (604).

The agent 115 changes the volume information 610 according to the received connection target changing request. Specifically, the agent 115 extracts one record of the volume information 610 of the volume name 611 which coincides with the volume name (volume 5) of the connection target changing request. For the extracted record of the volume information 610, the agent 115 changes the connection target iSCSI name 612 to the iSCSI name 222 (storage 1) of the connection target changing request, and the LUN 613 to the LUN (5) of the connection target changing request. By this process, the volume information 610 is changed from FIG. 17A to FIG. 17B.

On the other hand, in the case of releasing the external connection, the external connection changing program 110 collates the changing request of the external connection 220 with the agent constitution information 620, compares the iSCSI name 222 with the connection target iSCSI name 624, and further compares the LUN 223 with the LUN 625. The external connection changing program 110 obtains one record of the agent constitution information 620 in which both of the iSCSI name and the LUN coincide with each other. The external connection changing program 110 searches the agent 115 from the computer 114 of the host name 621 contained in the obtained record (605).

Moreover, for the obtained record of the agent constitution information 620, the external connection changing program 110 changes the connection target iSCSI name 624 to the Remote iSCSI name 224 of the changing request of the external connection 220, and the LUN 625 to the Remote LUN 225 of the changing request of the external connection 220.

Next, the external connection changing program 110 sends the connection target changing request to the searched agent 115 (606). The connection target changing request includes the volume name 623 contained in the obtained record of the agent constitution information 620, the Remote iSCSI name 224 of the changing request of the external connection 220, and the Remote LUN 225 of the changing request of the external connection 220.

The agent 115 that has received the connection target changing request changes the volume information 610 as in the case of the agent 115 that has received the connection target changing request in step 604 described above.

Next, the external connection changing program 110 searches one record of the logical volume information 150 which coincides with the iSCSI name 222 of the changing request of the external connection 220, the LUN 223, the Remote iSCSI name 224, and the Remote LUN 225. Then, the external connection changing program 110 sends a request of deleting the searched record of the volume information 150 to the storage management server 112 (607).

The storage management server 112 that has received the request deletes the one record from the volume information 150.

The embodiment of this invention has been described by way of example in which the process is carried out through the IP-SAN. However, this invention can be applied to a SAN comprising a Fiber Channel (FC) or a SAN comprising a mixture of an FC and an IP.

While the present invention has been described in detail and pictorially in the accompanying drawings, the present invention is not limited to such detail but covers various obvious modifications and equivalent arrangements, which fall within the purview of the appended claims.

What is claimed is:

1. A storage connection changing method for a storage management system of setting and releasing an external connection between a primary storage system and an external storage system in a storage system, the storage management system comprising:
a computer provided with a CPU, a memory, and an I/F module;
the primary storage system directly accessed by the computer;
the external storage system not directly accessed by the computer;
a network device which connects the computer, the primary storage system, and the external storage system; and
a management device which manages the computer, the primary storage system, the external storage system, and the network device, the method comprising:
upon receiving of a request for changing an external connection state;
the management device:
obtaining a communication group information for limiting a communicable range between the computer and the storage systems from the network device; and
generating a communication group information after the changing of the external connection state based on the request for changing the external connection state and the obtained communication group information.

2. The method according to claim 1, wherein the management device obtains first storage setting information set in the primary storage system, obtains second storage setting information set in the external storage system, and generates first storage setting information and second storage setting information after the changing of the external connection state based on the request for changing the external connection state, the obtained first storage setting information, and the obtained second storage setting information.

3. The method according to claim 1,
wherein the storage system further comprises a name solution server which manages a name solution group information for searching a communicable range of the computer, the primary storage system, and the external storage system,
wherein the management device obtains the name solution group information from the name solution server, and generates a name solution group information after the changing of the external connection state based on the request for changing the external connection state and the name solution group information.

4. The method according to claim 1, wherein when setting the external connection, the management device generates the communication group information after the setting of the external connection such that a communication port of the primary storage system belongs to a communication group to which a communication port of the external storage system before the setting belongs, and an external connection communication port of the primary storage system and the communication port of the external storage system belong to the same communication group.

5. The method according to claim 1, wherein when releasing the external connection, the management device generates the communication group information after the releasing of the external connection such that a communication port of the external storage system belongs to a communication group to which a communication port of the primary storage system belongs.

6. The method according to claim 3, wherein when setting the external connection, the management device generates the name solution group information after the setting of the external connection such that a communication port of the primary storage system belongs to a name solution group to which a communication port of the external storage system before the setting belongs, and an external connection communication port of the primary storage system and the communication port of the external storage system belong to the same name solution group.

7. The method according to claim 1, wherein when releasing the external connection, the management device generates the name solution group information after the releasing of the external connection such that a communication port of the external storage system belongs to a name solution group to which a communication port of the primary storage system belongs.

8. A storage management system, comprising:
a computer provided with a CPU, a memory, and an I/F module;
a primary storage system directly accessed by the computer;
an external storage system not directly accessed by the computer;
a network device which connects the computer, the primary storage system, and the external storage system; and
a management device which manages the computer, the primary storage system, the external storage system, and the network device,
wherein the storage management system changes an external connection state between the primary storage system and the external storage system in a storage system,
wherein the management device obtains a communication group information for limiting a communicable range between the computer and the storage systems from the network device upon receiving of a request for changing an external connection state,
wherein the management device generates a communication group information after the changing of external connection state based on the request for changing the external connection state and the obtained communication group information.

9. A computer program product which controls the management device to execute the storage connection state changing method of claim 1.
